(19) United States
(12) Patent Application Publication
(10) Pub. No.: US 2016/0114441 A1
(43) Pub. Date: Apr. 28, 2016

(54) DEVICE FOR GENERATING A ROTATORY ULTRASONIC VIBRATION ON A TOOL

(71) Applicant: TECHNISCHE UNIVERSITÄT MÜNCHEN, München (DE)

(72) Inventors: Matthias BAUR, Dietenheim (DE); Fabian DISTEL, Ismaning (DE)

(73) Assignee: Technische Universität München, München (DE)

(21) Appl. No.: 14/889,745

(22) PCT Filed: May 5, 2014
(86) PCT No.: PCT/EP2014/059117

§ 371 Date: Nov. 6, 2015

(30) Foreign Application Priority Data
May 8, 2013 (DE) 10 2013 007 957.8

(51) Int. Cl. B23Q 1/34; B06B 1/06; B23Q 3/12; B23B 37/00; B23C 5/26

(52) U.S. Cl. CPC B23Q 1/34; B23B 37/00; B23C 5/26; B23Q 3/12; B06B 1/0607; B23B 2260/108; B23B 2270/10; B23C 2270/10

(57) ABSTRACT

A device adapted for generating a rotatory ultrasonic vibration on a tool that includes a first part which is adapted for the rotationally fixed connection of the device to a spindle of a machine tool that rotates about an axis of rotation, and a second part which is adapted for the rotationally fixed connection of the device to a tool. The device also includes a claw coupling which is configured to connect the first and second parts for rotation with one another and has a form fit of at least one first flank on the first part and at least one second flank, lying opposite the first flank, on the second part. The device also includes at least one piezoelectric oscillation element arranged between first and second flanks of the claw coupling configured for generating a rotatory ultrasonic vibration about the axis of rotation.

The present invention refers to a device for generating a rotatory ultrasonic vibration on a tool. Specifically, an ultrasonic vibration is generated in the direction of rotation with the device on a rotating tool.

In various technical fields high-performance materials, such as e.g. high temperature-resistant nickel base alloys, titanium or chromium-cobalt alloys, or fiber-reinforced plastics, are increasingly used. The high-performance materials, however, put up a great resistance not only to the loads arising during operation, but also to the machining operation. Against this background hybrid machining devices have been developed, in which chip removal is supported by superimposing ultrasonic vibrations.

DE 10 2008 052 326 A1, for instance, shows the use of a piezoelectric shear oscillator for generating rotatory ultrasonic vibrations for machining purposes. The ultrasonic vibration is here operative in the direction of rotation of the tool. Piezoelectric shear oscillators, however, can only generate a very small oscillation amplitude, with an unfavorable force flow occurring at the same time.

It is the object of the present invention to indicate a device for generating a rotatory ultrasonic vibration on a tool, which device allows an ultrasonic vibration of a tool in the direction of rotation of the tool while having a cost-effective design and showing a low-maintenance operation.

The object is achieved with the features of the independent claim. The dependent claims refer to advantageous developments of the invention.

Hence, the object is achieved with a device for generating a rotatory ultrasonic vibration on a tool. The device comprises a first part. Said first part is designed for the rotationally fixed connection of the device to a spindle of a machine tool. Said spindle rotates about an axis of rotation. Furthermore, the device comprises a second part. The second part is designed for the rotationally fixed connection of the device to a tool. The two parts, i.e. the first part and the second part of the device, are connected to each other in a rotationally fixed manner via a claw coupling. Said claw coupling is designed as an integral component of the first and the second part. The claw coupling connects the two parts in a form-fit manner. Said form fit comprises at least one first flank on the first part and one second flank on the second part. Said two flanks are opposite to each other such that a torque about the axis of rotation can be transmitted from the first part to the second part. Furthermore, the device comprises at least one piezoelectric oscillation element. The piezoelectric oscillation element is positioned between the two flanks of the claw coupling. When voltage is applied to the piezoelectric oscillation element, said element will expand or contract. A rotatory ultrasonic vibration about the axis of rotation can thereby be generated. With the help of the device according to the invention the torque is transmitted from the rotating spindle of the machine tool to the tool on the one hand and said rotational movement is simultaneously superimposed with the ultrasonic vibration on the other hand.

Since the rotational movement of the tool is superimposed according to the invention with the ultrasonic vibration, the cutting forces can be reduced during machining. This is done by interrupting the cutting operation by way of the ultrasonic vibration. This leads to a chip formation that is more advantageous in comparison with the conventional machining process without ultrasonic vibration. Furthermore, the device according to the invention allows the cutting of materials that traditionally cannot be cut or cannot be cut economically. Since the cutting forces are reduced and a reduced friction occurs, the tool wear is reduced. At the same time the rotatory ultrasonic vibration allows a very fine surface roughness and a small bur formation on the workpiece. Especially the reduced tool wear allows a better dimensional stability of the tool.

Preferably, the first part comprises a plurality of first claws extending in the direction of the axis of rotation. Consequently, the second part comprises a plurality of second claws extending in the direction of the axis of rotation. Each of the first claws comprises two first flanks. Each of the second flanks comprises two second flanks. The first and second claws engage one another on the claw coupling, so that the torque is transmitted from the first part to the second part over a plurality of flanks and thus over an area that is as large as possible. It is apparent to the person skilled in the art that at least a first flank and a second flank must be available for transmitting the torque. In an advantageous configuration several claws with a corresponding large number of flanks are provided. Hence, piezoelectric oscillation elements are preferably used between all flanks or between several flanks. The individual piezoelectric oscillation element is then arranged between a first and a second flank.

It is preferably provided that the least one piezoelectric oscillation element is a thickness oscillator, i.e. a longitudinal or transverse oscillator. According to the invention the piezoelectric oscillation elements are arranged between the first and second flanks of a claw coupling. It is thereby possible to use simple piezoelectric oscillation elements that upon voltage application will increase or decrease their thickness. The piezoelectric oscillation elements are here preferably arranged such that they change their thickness in a direction tangential to the circumferential direction of the device for generating the rotatory ultrasonic vibration. The circumferential direction is here defined about the axis of rotation of the spindle. Hence, shear oscillators need not be used according to the invention.

When several claws and thus several piezoelectric oscillation elements are used, the piezoelectric oscillation elements are preferably arranged concentrically around the axis of rotation. The piezoelectric oscillation elements are preferably arranged as far as possible outside the axis of rotation to exert a torque that is as great as possible.

Preferably, all of the used piezoelectric oscillation elements are arranged with respect to their polarity and contacting such as to be operative in the same direction during generation of the rotatory ultrasonic vibration is generated. The piezoelectric oscillation elements do thereby not interfere with one another.

Preferably, it is provided that the two parts of the device are interconnected via at least one tension element. Said tension element preferably extends in the direction of the axis of rotation. Specifically, the tension element is arranged to be coaxial to the axis of rotation. The two parts are preferably screwed together by way of the tension element.

Furthermore, it is preferably provided that the at least one piezoelectric oscillation element simultaneously abuts on the first flank and on the second flank. As a consequence, there is no play between the flanks and the at least one piezoelectric oscillation element.

Furthermore, it is preferably provided that the first and the second flank are inclined relative to the axis of rotation. It is here defined that the respective surface normals of the flanks are inclined by an angle α relative to the axis of rotation. Said angle α is particularly 45° to 89°, particularly preferably 60° to 85°. Furthermore, it is preferably provided that the surface normals are oriented to be tangential to the circumferential direction.

Furthermore, it is preferably provided that respectively opposite flanks are oriented in parallel with each other. As an alternative, it is provided that respectively opposite flanks are not oriented in parallel with each other, i.e. the surface normals thereof enclose an angle χ and that the piezoelectric oscillation element which is arranged between two opposite flanks is wedge-shaped. In this case the opposite flanks are not inclined by the same angle α relative to the axis of rotation.

The at least one piezoelectric oscillation element can be preloaded in the claw coupling by way of the inclination of the flanks. This is particularly possible when the tension element is used. Preferably, the preload on the at least one piezoelectric oscillation element can be set to be variable.

Preferably, the at least one flank is used as the electrode of the at least one piezoelectric element. The first and/or second part can particularly be used as electrode/electrodes when longitudinal oscillators are used. As an alternative or in addition, electrodes can be introduced between the piezoelectric oscillation elements and the claws.

When a piezoelectric oscillation element is used that is designed as a transverse oscillator, electrodes are preferably mounted on the free front faces of the piezoelectric oscillation element.

When additional electrodes are used, the claws are preferably electrically insulated relative to the piezoelectric oscillation elements. This is preferably done with ceramic discs.

A control unit is preferably provided for applying voltage to the at least one piezoelectric oscillation element. With the help of this control unit the device is preferably operated at its resonant frequency such as to achieve an oscillation amplitude that is as high as possible. When several piezoelectric oscillation elements are used, these are preferably arranged and controlled such that they alternatingly contract and expand.

The first part is designed for the rotationally fixed connection of the device to the spindle of the machine tool. This connection is preferably established via a steep taper or a hollow shank taper. The connection between the second part and the tool is preferably established via collect chucks or a shrink chuck.

The invention further comprises a machine tool, particularly a miller. The machine tool comprises one of the devices as have just been described above. The first part is here connected to a rotating spindle of the machine tool for rotation therewith.

An embodiment of the invention will now be described in detail with reference to the accompanying drawing, in which

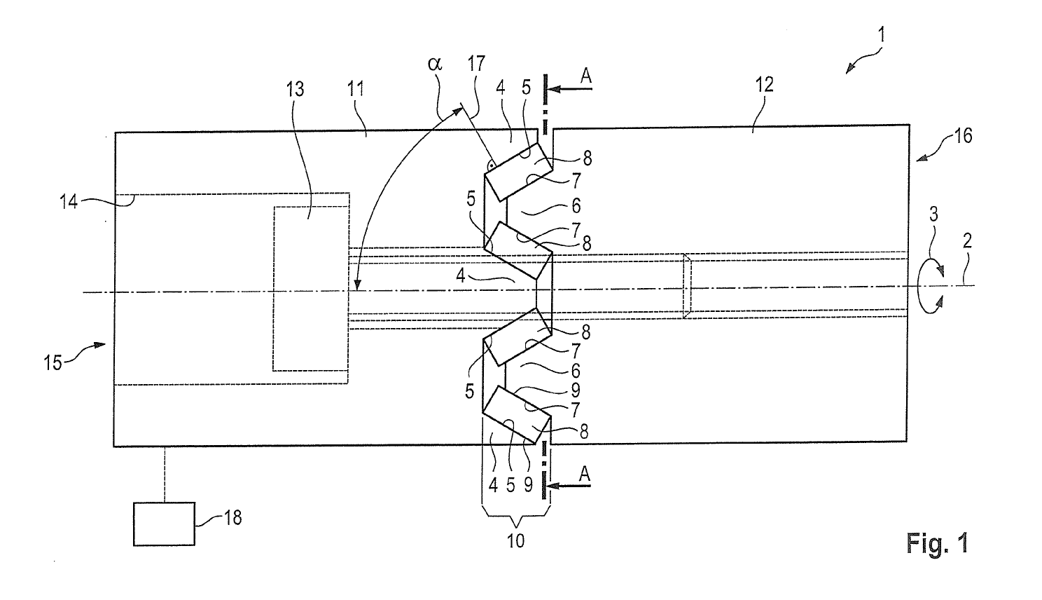

FIG. 1 shows a device of the invention according to an embodiment in a side view; and

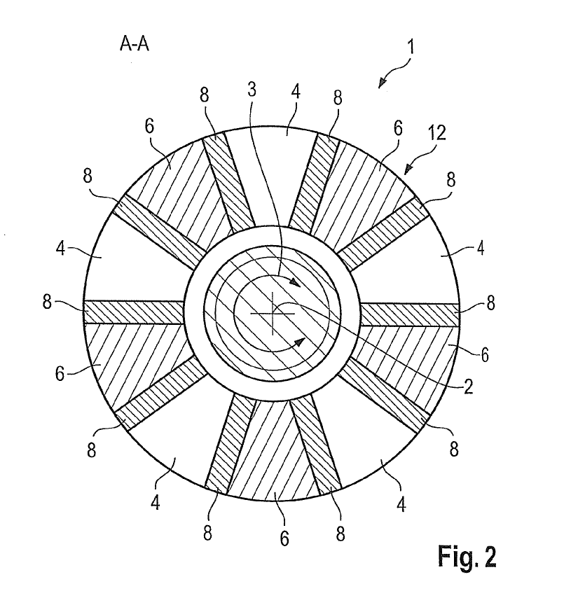

FIG. 2 shows an axial section of the device of the invention according to the embodiment of FIG. 1.

FIGS. 1 and 2 show two views of a device 1 for generating a rotatory ultrasonic vibration on a tool.

The device 1 comprises a first part 11, a second part 12 and a plurality of piezoelectric oscillation elements 8. The piezoelectric oscillation elements 8 are designed as longitudinal or transverse oscillators. Furthermore, the device 1 comprises a control unit 18 for controlling the piezoelectric oscillation elements 8. The control unit 18 is shown in a purely diagrammatic manner.

The first part 11 has a spindle connection 15, which is shown in a purely diagrammatic manner. The first part 11 is connectable via said spindle connection 15 to a rotating spindle of a machine tool for rotation therewith. Said spindle rotates about an axis of rotation 2. Thus the device 1 and an associated tool also rotate about the axis of rotation 2.

The second part 12 has a tool connection 16, which is shown in a purely diagrammatic manner. The second part 12 is connected via said tool connection 16 to a tool, particularly a miller, for rotation therewith.

A circumferential direction 3 is defined in accordance with the axis of rotation 2.

A claw coupling 10 is formed on both parts 11, 12. The first part 11 comprises a plurality of first claws 4. A first flank 5 is respectively defined at both sides of each first claw 4. The second part 12 comprises a plurality of second claws 6. A second flank 7 is respectively defined at both sides of each second claw 6. The claws 4, 6 engage one another, so that a torque about the axis of rotation 2 can be transmitted from the first part 11 to the second part 12 via the flanks 5, 7.

One of the piezoelectric oscillation elements 8 is respectively arranged between a first flank 5 and a second flank 7. Depending on the design of the piezoelectric oscillation element 8, said element comprises corresponding electrodes and insulators.

By applying voltage to the piezoelectric oscillation elements 8 by way of the control unit 18, the piezoelectric oscillation elements 8 will change their thickness. An ultrasonic vibration can thereby be transmitted to the second part 12 and thus to the tool. Said ultrasonic vibration is oriented in circumferential direction 3. The ultrasonic vibration thereby superimposes the rotational movement generated by the spindle.

The surface normals 17 to the first and second flanks 5, 7 are inclined by an angle α relative to the axis of rotation 2. Directly opposite flanks 5, 7 are oriented in parallel with each other. The device 1 further comprises a tension element 13. Said tension element 13 extends in the direction of the axis of rotation 2. The two parts 11, 12 are screwed together via the tension element 13. At the same time the tension element 13 exerts a preload on the piezoelectric oscillation elements 8 via the inclined flanks 5, 7.

A front-side pocket 14 is provided in the first part 11, said pocket receiving the head of the tension element 13. The second part 12 comprises a corresponding thread for accommodating the tension element 13.

The piezoelectric oscillation elements 8 respectively comprise two opposite support surfaces 9. Said support surfaces 9 directly contact the first flank 5 and the second flank 7, respectively.

The embodiment shows that the rotatory movement of a tool can be superimposed with a rotatory ultrasonic vibration by way of the device 1. This is particularly used for ultrasound-assisted milling. The used piezoelectric oscillation elements 8 are thickness oscillators, i.e. longitudinal or transverse oscillators. According to the invention no translational vibration is generated in the direction of the axis of rotation 2. Piezoelectric shear effects are also not needed. The translational vibration would have the drawback that the surface quality of the workpiece would be poor in the machining process. The piezoelectric shear effects would have the drawback that only small amplitudes and correspondingly small processing forces are possible because the complete process force acts as a shear force on the piezoceramics. This would be an unfavorable load for the piezoelectric elements. According to the invention the piezoelectric oscillation elements 8 are acted upon in the direction of pressure and can thus transmit considerably higher forces, whereby very high material removal rates in ultrasound-assisted milling are possible with the illustrated device 1.

### LIST OF REFERENCE NUMERALS

device

2 axis of rotation

3 circumferential direction

4 first claws

5 first flanks

6 second claws

7 second flanks

8 piezoelectric oscillation elements

9 support surfaces

10 claw coupling

11 first part

12 second part

13 tension element

14 front-side pocket

15 spindle connection

16 tool connection

17 surface normal

18 control unit

1. A device adapted for generating a rotatory ultrasonic vibration on a tool, comprising:
a first part which is adapted for the rotationally fixed connection of the device to a spindle of a machine tool that rotates about an axis of rotation,
a second part which is adapted for the rotationally fixed connection of the device to a tool,
a claw coupling which is configured to connect the first part and the second part for rotation with one another and has a form fit of at least one first flank on the first part and at least one second flank, lying opposite the first flank, on the second part, and
at least one piezoelectric oscillation element arranged between the first flank and the second flank of the claw coupling configured for generating a rotatory ultrasonic vibration about the axis of rotation.

2. The device according to claim 1, characterized in that the at least one piezoelectric oscillation element is a longitudinal of oscillator.

3. The device according to claim 1, characterized in that the at least one piezoelectric oscillation element is arranged to change its thickness in a direction tangential to a circumferential direction for generating the rotatory ultrasonic vibration, wherein the circumferential direction is defined around the axis of rotation.

4. The device according to claim 1, characterized in that a plurality of the piezoelectric oscillation elements are arranged with respect to their polarity and contacting such as all of the piezoelectric oscillation elements to be operative in the same direction during generation of the rotatory ultrasonic vibration.

5. The device according to claim 1, characterized in that the first part and the second part are interconnected via at least one tension element.

6. The device according to claim 5, characterized in that the tension element extends in the direction of the axis of rotation.

7. The device according to claim 1, characterized in that the at least one piezoelectric oscillation element abuts on the first flank and on the second flank at the same time.

8. The device according to claim 1, characterized in that respective surface normals of the first flank and the second flank are inclined by an angle α relative to the axis of rotation.

9. The device according to claim 8, characterized in that the angle α is between 45° and 89°.

10. The device according to claim 1, characterized in that the first flank is oriented in parallel with the opposite second flank.

11. The device according to claim 1, characterized by a control unit for applying voltage to the at least one piezoelectric oscillation element.

12. The device according to claim 1, characterized in that the first part comprises a plurality of first claws extending in the direction of the axis of rotation, and the second part comprises a plurality of second claws extending in the direction of the axis of rotation, wherein the first claw and the second claw alternatingly engage one another.

13. The device according to claim 12, characterized in that a piezoelectric oscillation element is respectively arranged between a first claw and a second claw.

14. A machine tool, preferably a miller, comprising the device of claim 1, wherein the first part is connected to a rotating spindle of the machine tool for rotation therewith.

15. The device according to claim 8, characterized in that the angle α is between 60° and 85°.

16. The device according to claim 2, characterized in that the at least one piezoelectric oscillation element is arranged to change its thickness in a direction tangential to a circumferential direction for generating the rotatory ultrasonic vibration, wherein the circumferential direction is defined around the axis of rotation.

17. The device according to claim 16, characterized in that a plurality of the piezoelectric oscillation elements are arranged with respect to their polarity and contacting such as all of the piezoelectric oscillation elements to be operative in the same direction during generation of the rotatory ultrasonic vibration.

18. The device according to claim 17, characterized in that the first part and the second part are interconnected via at least one tension element.

19. The device according to claim 18, characterized in that the tension element extends in the direction of the axis of rotation.

20. The device according to claim 1, characterized in that the at least one piezoelectric oscillation element is a transverse oscillator.
